(19) United States
(12) Patent Application Publication
(10) Pub. No.: US 2008/0053758 A1
(43) Pub. Date: Mar. 6, 2008

(54) BRAKE SYSTEM WITH HYDRAULIC BRAKE EQUIPMENT

(75) Inventors: Stefan Ruckh, Romerstein/Zainingen (DE); Jurgen Beier, Ulm (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: GUSTAV MAGENWIRTH GMBH & CO. KG, Bad Urach (DE)

(21) Appl. No.: 11/846,584

(22) Filed: Aug. 29, 2007

(30) Foreign Application Priority Data
Aug. 29, 2006 (DE) 102006040327.4

(51) Int. Cl. B62L 3/02

(52) U.S. Cl. 188/26

(57) ABSTRACT

A hydraulic brake system for two-wheel vehicles, especially bicycles, is provided. The system has a dispensing system filled with hydraulic fluid and a brake mechanism hydraulically connected to the dispensing system. The dispensing system has an equalizing reservoir and a filling and bleeding opening. The filling and bleeding opening has an insertion section arranged in a cover of the equalizing reservoir for tight holding of a bleeding and filling tool, which connects in the insertion direction to a connection chamber in the dispenser housing, which has a side boundary wall to the equalizing reservoir, and that at least one overflow opening that is open at the edge to the equalizing reservoir is provided in the boundary wall.

### FIELD OF THE INVENTION

The invention relates to a brake system with hydraulic brake equipment for two-wheel vehicles, especially bicycles, wherein the brake equipment has a dispensing system filled with hydraulic fluid and a brake mechanism connected to this dispensing system hydraulically, with the dispensing system having an equalizing reservoir and a filling and bleeding opening.

### BACKGROUND

The invention relates to a brake system with hydraulic brake equipment for two-wheel vehicles, especially bicycles, wherein the brake equipment has a dispensing system filled with hydraulic fluid and a brake mechanism connected to this dispensing system hydraulically, with the dispensing system having an equalizing reservoir and a filling and bleeding opening.

Such a dispensing system features a housing containing, as part of a main cylinder, a dispenser piston cylinder and a dispenser piston, which is guided in this cylinder and which can be activated by means of a hand lever. In addition, the dispensing system features the equalizing reservoir filled with hydraulic fluid as a reserve chamber for volume equalization when the hydraulic fluid heats up and cools down.

The housing of the dispensing system with an equalizing reservoir is frequently produced using the pressure-die-casting or injection-molding technique. The mold necessary for this technique must be shaped according to the provided hollows in the dispenser housing. For known brake systems, the inner hollows and here also the filling and bleeding opening connected to the equalizing reservoir are arranged in the dispenser housing, so that this housing and also connecting channels projecting from this housing to the equalizing reservoir are difficult to produce using a casting technique.

### SUMMARY

The object of the present invention is to arrange the filling and bleeding opening of the equalizing reservoir and the attached connecting channels in a brake system of the type named above, so that, on one hand, a simple production of the dispenser housing and parts connected to this housing is promoted and so that, on the other hand, the brake system can be easily filled and bled dribble-free without contaminating the surroundings with brake fluid.

To this end, it is proposed that the filling and bleeding opening has an insertion section arranged in a cover of the equalizing reservoir for the tight holding of a bleeding and filling tool connected in the insertion direction to a connection chamber in the dispenser housing, which has a side boundary wall to the equalizing reservoir, and that at least one overflow opening that is open at the edge is provided in the boundary wall as a flow passage to the equalizing reservoir.

The filling and bleeding opening is thus arranged in the region of the cover of the equalizing reservoir and thus on the top side of the dispensing system, which gives a favorable position for the filling and bleeding from the front.

The insertion section in the cover is a through hole, which, for the production of the cover in a mold, can be produced easily by a complementary shaped pin. The connection chamber in the dispenser housing can also be molded easily by a molding pin. Both sections of the filling and bleeding opening are preferably oriented in the ejection direction of the mold, so that problem-free ejection from the mold is possible.

The overflow opening, which is open at the edge and which is oriented similarly in the ejection direction, also contributes to a simple construction of the mold. Thus, complicated auxiliary devices in the mold are unnecessary, so that an especially economic production of the parts is possible.

In the insertion section in the cover, the bleeding and filling tool is held securely after insertion and in a simple way a flow connection to the equalizing reservoir is provided via the connection chamber and the overflow opening.

Through the secure holding of the bleeding and filling tool, for emptying, filling, and bleeding the hydraulic system, it is achieved that no brake fluid or hydraulic fluid leaks out and causes damage to vehicle components or makes these unusable. Also, skin contact with hydraulic fluid is reliably prevented. From the reasons named above, up until now relatively large, difficult to handle equipment, which could present problems to an inexperienced user, has to be used when handling brake fluid during the filling and bleeding.

Preferably, the insertion section of the filling and bleeding opening is constructed for tight holding of a connecting sleeve of the bleeding and filling tool, wherein the connecting sleeve projects into the connection chamber in the connection position and wherein the connection chamber has open internal dimensions, which are greater than the projecting part of the connecting sleeve.

Therefore, in the connection chamber there is sufficient space around the connecting sleeve so that the fluid (hydraulic fluid, air) can be led via the overflow opening to the connection chamber and vice versa.

It is especially advantageous when the overflow opening that is open at the edge is arranged in the boundary wall of the connection chamber at a diagonal operating position of the corresponding adjustable dispensing system in a lower-lying region at a distance from the highest position of the side boundary wall.

Therefore the connection chamber forms an air trap for air bubbles in the hydraulic fluid. These bubbles remain trapped in the connection chamber due to the lower arrangement of the overflow opening in relation to the highest position of the internal space of the connection chamber and cannot be led into the equalizing reservoir and into the further hydraulic circuit.

According to one embodiment, two overflow openings, which are open at the edge and which are arranged preferably approximately opposite each other, are provided in the boundary wall. These are then positioned offset by approximately 90° or more relative to the highest position of the internal space of the connection chamber.

According to an advantageous improvement of the invention, the overflow openings arranged in the boundary wall of the connection chamber are formed as narrow edge slots, wherein the slot width is dimensioned for keeping back air bubbles contained in the hydraulic fluid. Here, air bubbles, in particular, which rise in the hydraulic fluid due to the force of gravity, are kept back.

According to one embodiment of the invention, it is provided that the cover overlapping the equalizing reservoir and forming a seal contact on the housing at the edges has the insertion section for the bleeding and filling tool at the side next to the equalizing reservoir and that the cup-shaped connection chamber connected in the insertion direction is located in the dispenser housing.

In this way, the filling and bleeding opening is located on the side next to the equalizing reservoir, which is located in a diagonal filling and bleeding position at an elevated position, because in this way, on one hand, the bleeding is promoted and, on the other hand, fluid is prevented from running out when coupling and decoupling the bleeding and filling tool.

The connection chamber is arranged in the embodiment named above in a bulge of the dispenser housing projecting into the equalizing reservoir, so that the side boundary wall contacts the equalizing reservoir directly in some regions. By means of the bulge, side wall regions are provided, in which the overflow openings can be arranged at a distance to the wall region projecting farthest into the equalizing reservoir.

According to another embodiment of the invention, it is provided that the filling and bleeding opening is arranged in the region of the cover overlapping the equalizing reservoir, wherein the insertion section passes through the cover and wherein the connection chamber connected tightly in the insertion direction is located in the dispenser housing in a housing projection located within the equalizing reservoir.

This embodiment can then be provided, among other things, when there is no space for the filling and bleeding opening on the side next to the equalizing reservoir or the cover sealing it on the top side. The housing projection can here extend like an island from the base of the equalizing reservoir towards the inside of the cover, wherein the connection chamber is located in the upper end and connects tightly to the insertion section in the cover. The overflow opening or also several overflow openings are also located here in the upper edge of the connection chamber and thus are positioned so that in the operating position, where the dispensing system is diagonal with one side lowered, air bubbles in the connection chamber cannot be led into the equalizing reservoir via the overflow opening(s).

To be able to set the different positions of the dispensing system, this can be connected to a part of the two-wheel vehicle, preferably to the handlebars, by means of a holder. The holder is constructed for moving the dispensing system at least, on one hand, into the filling and bleeding position and, on the other hand, into an operating position. In the filling and bleeding position, the filling and bleeding opening is located in the topmost position of the hydraulic system.

Preferably, between the equalizing reservoir and the cover sealing it at the top side there is a seal, which extends into the region between the insertion section and the adjacent connection chamber of the filling and bleeding opening. Thus, a seal between both the equalizing reservoir and the cover and also between the insertion section and the connection chamber of the filling and bleeding opening is provided.

The seal is advantageously thicker at least in the contact region on the boundary wall of the connection chamber, wherein the cover region facing it and surrounding the insertion section has an annular groove for holding the seal or the thicker seal region in a sealing way. The seal has increased inherent stability due to the thicker section, so that a good seal is given via the overflow opening or openings that are open at the edge also in the overlapping region of the seal.

Preferably, an elastic bellows is inserted into the equalizing reservoir. This bellows is preferably formed by a rubber-elastic molded body and has at least one surrounding side flange as a seal between the equalizing reservoir and the cover.

This bellows is used for volume equalization for a changing fill volume of the hydraulic fluid in the equalizing reservoir. The hydraulic system can be closed tightly from the outside.

The elastic bellows is hollow and formed especially trough-shaped with a surrounding, flange-like seal on the opening edge. As already mentioned, the seal of the bellows in the mounted position forms the seal between the equalizing reservoir and the cover, so that the bellows and the equalizing reservoir are simultaneously closed on the top side.

In the equalizing reservoir cover, there is a bellows bleeding opening, so that when the volume of the hydraulic fluid in the equalizing reservoir changes and the volume of the bellows changes accordingly, air in the interior of the bellows can escape or else can flow in from the outside.

According to one advantageous improvement of the invention, it is provided that the bottom side of the bellows forms a diagonal guiding surface to the bleeding position for the filling and bleeding opening at least in the filling and bleeding position of the dispensing system.

When the hydraulic system is bled or filled, air bubbles contained in the hydraulic fluid are guided along the roof-shaped rising guiding surface of the bellows in the direction of bleeding while rising in the hydraulic fluid, which promotes complete bleeding.

For clean (drip-free) filling of the hydraulic system with hydraulic fluid, a bleeding and filling tool allocated to the brake system has a connecting sleeve or a similar connecting element for sealed insertion into the filling and bleeding opening.

In this way, filling and/or bleeding of the hydraulic system can be performed essentially without additional aids. Here, the bleeding and filling tool can be inserted directly into the filling and bleeding opening or its insertion section and is then held in an approximately vertical or somewhat diagonal position. Additional aids for holding are not necessary. In particular, through a conical connection between a connecting sleeve and the filling and bleeding opening, a tight and secure connection, which is pressure-tight and vacuum-tight and which contributes to simple and clean handling during filling and bleeding processes, is provided just through an insertion process.

It is especially preferable when the connecting sleeve of the bleeding and filling tool has a Luer cone or a Luer lock and when the filling and bleeding opening or its insertion section fits the connecting sleeve. Both the Luer cone for insertion and also the Luer lock for screwing-in form proven, easy to handle, tight, and safe connections.

It is especially advantageous when the bleeding and filling tool has a piston/cylinder arrangement. In this way an especially good capability for dosing the hydraulic fluid to be filled is given. This is especially important in consideration of the low filling amount, for example, for hydraulic brake equipment for bicycles. In addition, both pressure and also a relatively high vacuum can be generated, through which, in addition to a flushing filling of the hydraulic system, also a suction filling of the hydraulic system is possible.

If a Luer cone or Luer lock is used as a conical connection, in an especially advantageous way, a standard syringe, which is available practically everywhere and which is economical and whose common fill volume of, for example, 10 ml or 20 ml, is sufficient for a complete filling and/or bleeding of a hydraulic system, especially for bicycles, could be used as the bleeding and filling tool without having to be attached and removed several times.

The bleeding and filling tool can also be integrated into the dispensing system, that is, be part of the dispensing system. Here, it can be attached permanently to the equalizing reservoir or else held in a holder and for the filling and bleeding process, it can be detached or removed and coupled tightly with the filling and bleeding opening.

According to one embodiment of the invention, the overflow opening from the connection chamber to the equalizing reservoir can be arranged in a counterpart contacting the boundary wall instead of in the boundary wall of the connection chamber. The counterpart contacting the boundary wall can be, in particular, the cover or a seal between the cover and the equalizing reservoir.

This is provided primarily when the introduction of one or more overflow openings into the connection chamber boundary wall is problematic.

This can be the case, for example, for a dispenser housing made from metal, especially from forged metal, because relatively filigree spheroidization and moldings can be realized here only with difficulty and, in particular, not without complicated finishing work.

In such a case, the overflow openings(s) from the connection chamber to the equalizing reservoir can be provided in the cover itself or in a seal between the cover and the equalizing reservoir.

Here, the overflow opening(s) can be constructed in their region overlapping the boundary wall with a channel shape as a groove that is open at the edge and that faces and overlaps the boundary wall with its opening.

Preferably, it is provided that the seal with the one or more overflow openings is the surrounding side flange of the elastic bellows.

### BRIEF DESCRIPTION OF THE DRAWINGS

Additional constructions of the invention are listed in the other subordinate claims. Below, the invention is described in more detail in one embodiment with reference to the drawings, in which:

FIG. 1 is a view of hydraulic brake equipment with a dispensing system and a brake mechanism arranged on a brake disk,

FIG. 2 is a section view of the dispensing system shown in FIG. 1,

FIG. 3 is a section view of the brake mechanism shown in FIG. 1,

FIG. 4 is a section view of a dispensing system in a filling and bleeding position with attached bleeding and filling tool,

FIG. 5 is a section view of the dispensing system in the operating position,

FIG. 6 is an enlarged view of the dispensing system from FIG. 4 in the filling and bleeding position,

FIG. 7 is an enlarged section view of the dispensing system from FIG. 5 in the operating position,

FIG. 8 is a top view of a dispensing system with open equalizing reservoir,

FIG. 9 is a top view of a dispensing system with attached bleeding and filling tool,

FIG. 10 is a top view of an equalizing reservoir cover,

FIG. 11 is a side view of the cover shown in FIG. 10,

FIG. 12 is an enlarged view of a cover region with a filling and bleeding opening,

FIG. 13 is a perspective view of a bellows,

FIG. 14 is a section view of the dispensing system with overflow openings in the surrounding side flange of an elastic bellows,

FIG. 15 is a narrow side view of a bellows with overflow openings, and

FIG. 16 is a bottom side view of the bellows shown in FIG. 15.

### DETAILED DESCRIPTION OF THE PREFERRED EMBODIMENTS

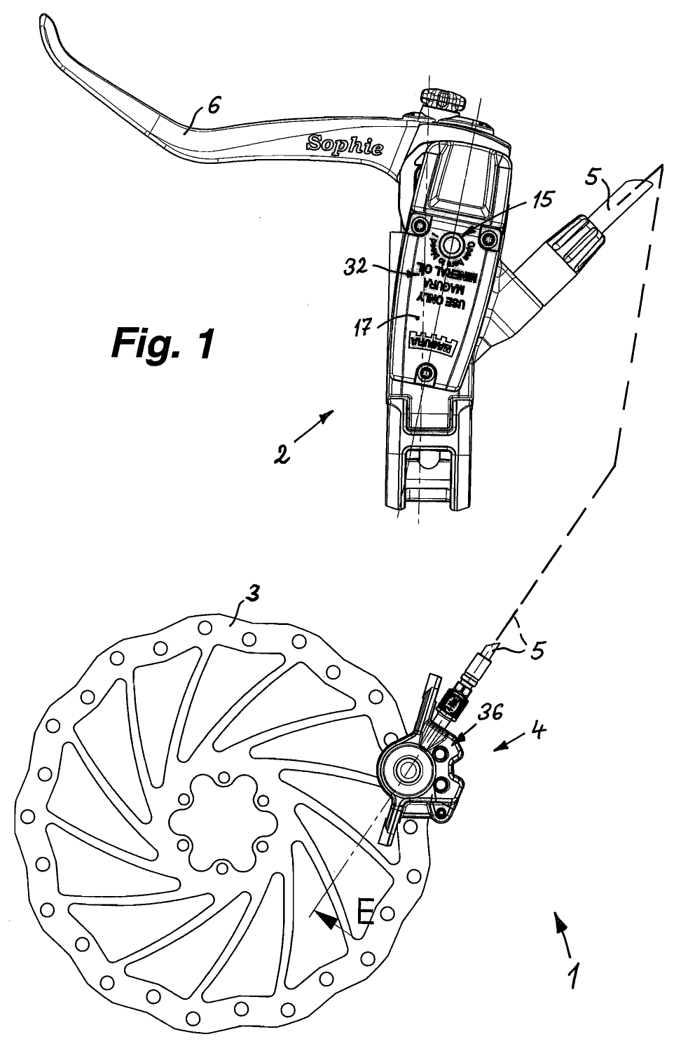

A hydraulic brake system 1 shown in FIG. 1 can be used especially for bicycles but also for other two-wheel vehicles. It has a dispensing system 2 and also a brake mechanism 4 attached to a brake disk 3. The brake system is filled with hydraulic fluid, with the dispensing system 2 being connected to the brake mechanism 4 via a hydraulic line 5 indicated with dashed lines.

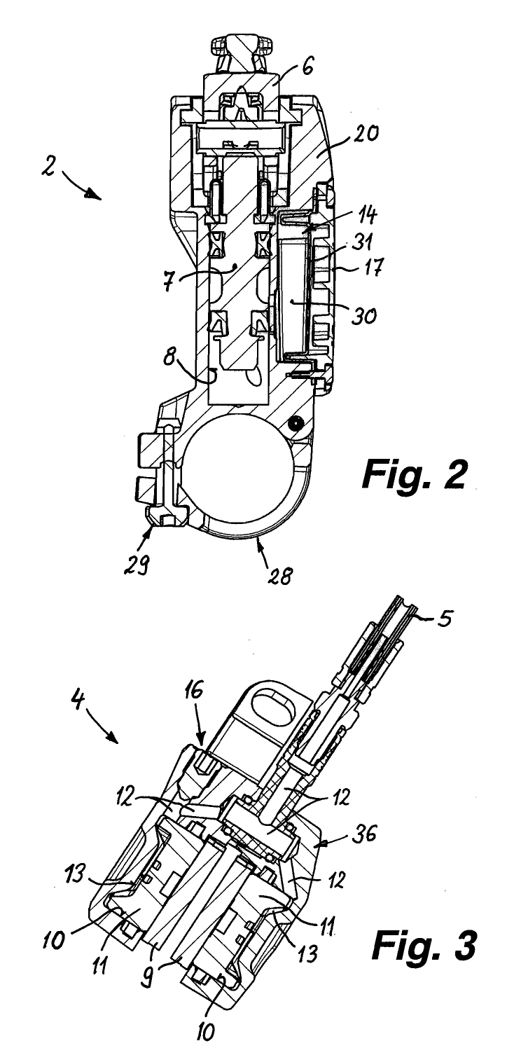

The dispensing system 2 has a hand-activated brake lever 6, with which a dispenser piston 7 (cf. FIG. 2) guided in a cylinder 8 can be moved and in this way, hydraulic fluid is led to the brake mechanism 4 via the hydraulic lining 5. This brake mechanism 4 has brake calipers 36 arranged on the brake disk 3 connected to the wheel to be braked. Force is applied to the brake disk 3 on both sides with two brake pads 9 during braking (FIG. 3). For this purpose, brake pistons 11, which are guided in brake cylinders 10 and which receive force on the back side from hydraulic fluid, are provided. The hydraulic fluid is guided from the hydraulic line 5 via channels 12 to pressure chambers 13 located behind the brake piston 11.

The dispensing system 2 has an equalizing reservoir 14 for hydraulic fluid, which is connected to the cylinder 8 and thus to the hydraulic circuit when the brake lever 6 is not activated.

To be able to fill and bleed the hydraulic system, the dispensing system 2 has a filling and bleeding opening 15 and the brake mechanism 4 also has a filling and bleeding opening 16 (FIG. 3).

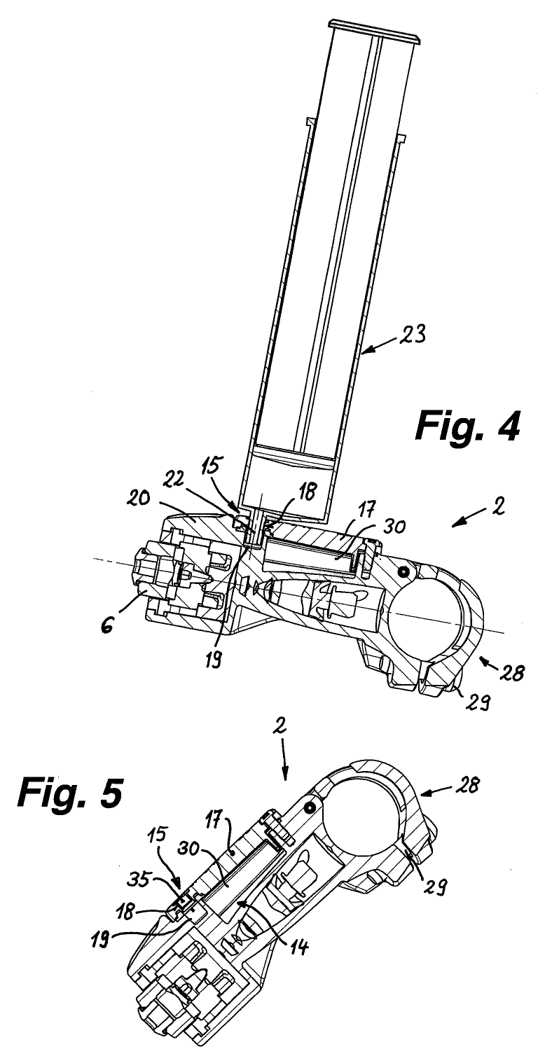

In the shown embodiment, the filling and bleeding opening 15 of the dispensing system 2 is provided on the top side of this system and passes through a cover 17 closing the equalizing reservoir 14 on the top side (FIGS. 4 to 7). This cover is connected by screws to the dispenser housing 20.

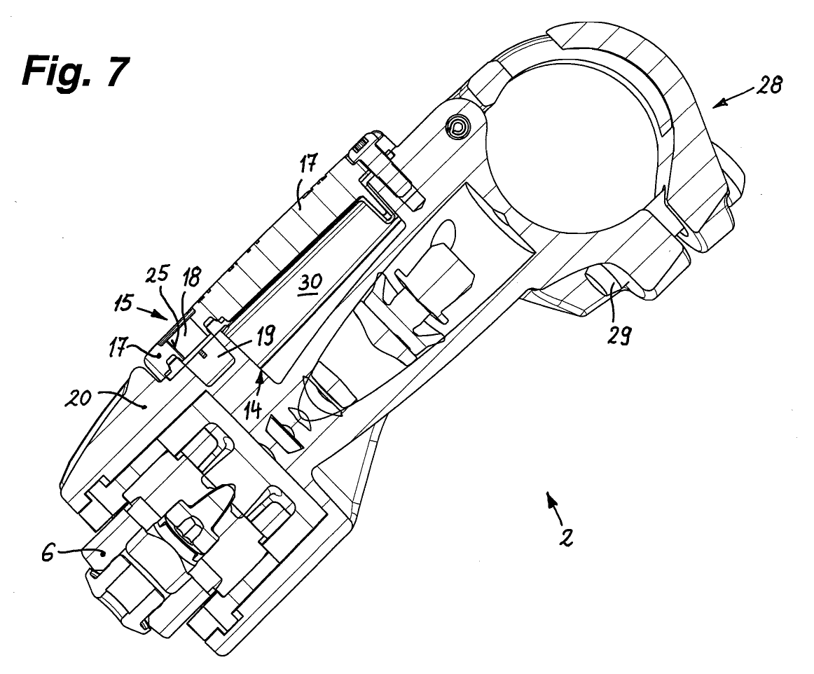

Especially in FIG. 7 it is easy to see that the filling and bleeding opening 15 in the cover 17 has an insertion section 18, which attaches to a connection chamber 19 in the dispenser housing 20 preferably flush in the axial projection. The connection chamber 19 has a pot or cup shape and at its top edge it has slot-shaped overflow openings 21 that are open at the edge to the equalizing reservoir 14. In this way there is a flow connection between this connection chamber 19 and the equalizing reservoir 14.

The construction of the filling and bleeding opening 15 forming a feed channel for the equalizing reservoir 14 divided, on one hand, into two preferably axially flush sections—insertion section 18, connection chamber 19—and arranged, on the other hand, in two parts that can be produced separately—cover 17, dispenser housing 17—has considerable advantages in terms of production, because it involves individual boreholes, which can be easily produced by molding pins. The feed channel of the filling and bleeding opening 15 involves a stepped borehole in the functional position with an inner step that is greater in diameter, which would signify increased complication in terms of molding for a one-piece construction due to the undercut.

The insertion section 18 in the cover 17 and the connection chamber 19 in the dispenser housing 20 are aligned with reference to their longitudinal axes so that they each run in the ejection direction of the cover or the dispenser housing and thus allow trouble-free removal from the molds. Through the construction of the preferably slot-shaped overflow openings 21, which are open at the edge and which are similarly oriented in the ejection direction, these can also be produced easily.

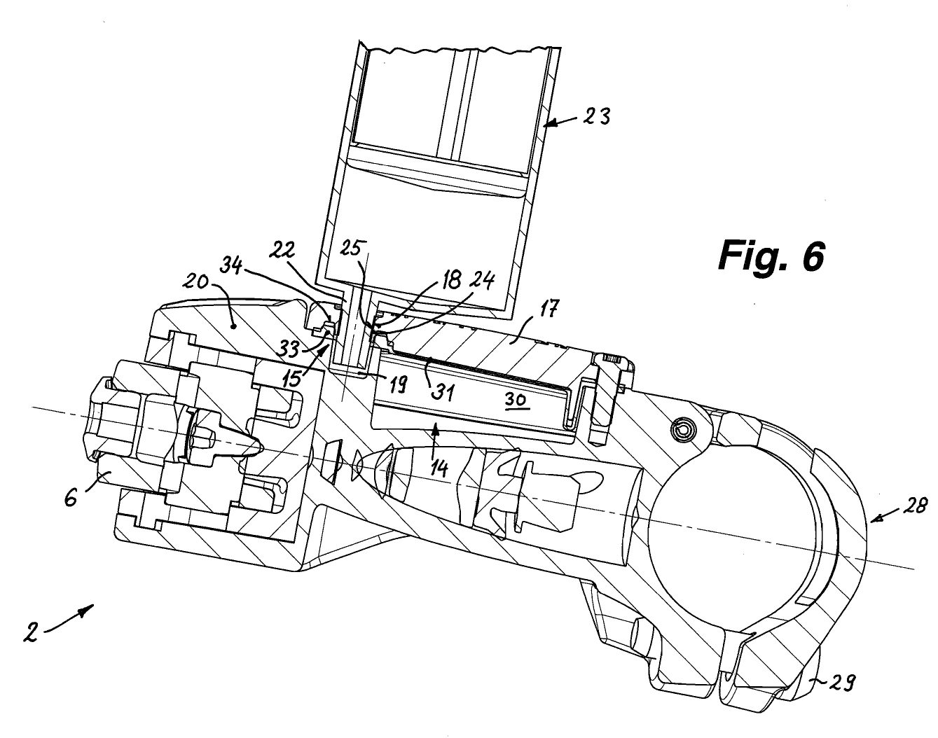

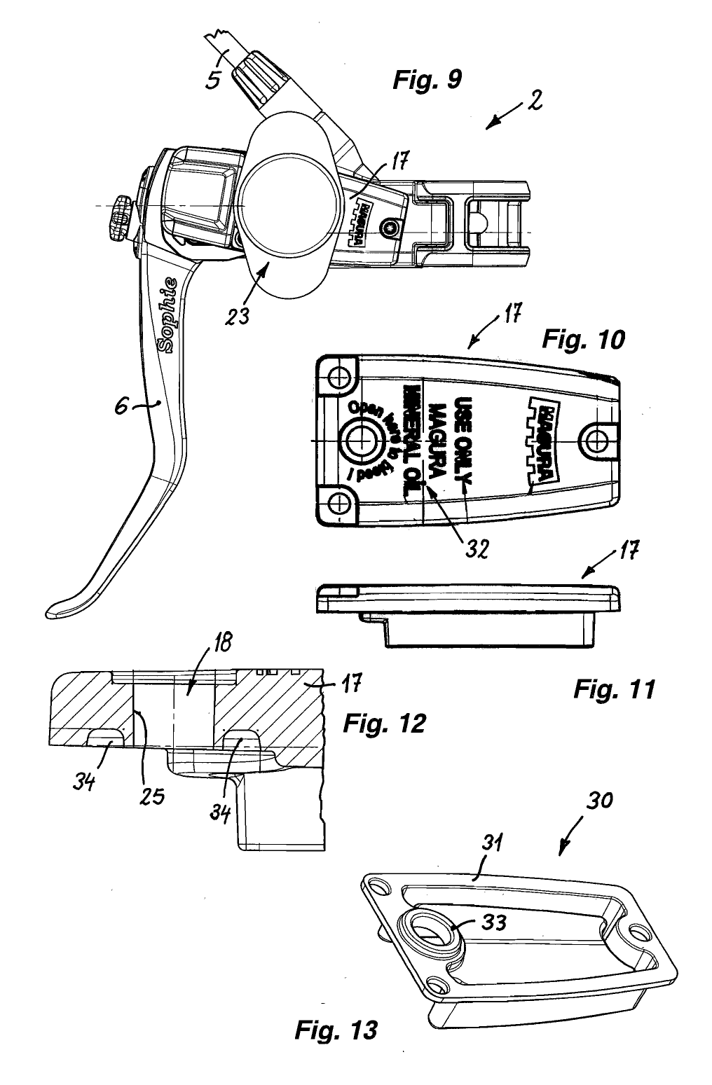

The insertion section 18 of the filling and bleeding opening 15 is constructed for the tight holding of the connecting sleeve 22 of the bleeding and filling tool 23 and for this purpose has a receiving cone 25. The receiving cone 25 is constructed preferably for receiving the insertion of a connecting sleeve 22 formed as a Luer cone 24 in the bleeding and filling tool 23 (FIG. 6). In this way, there is the possibility to use a standard syringe, as can be seen in FIGS. 4, 6, and 9, as the bleeding and filling tool 23.

The insertion connection with the receiving cone 25 and the connecting sleeve 22 is dimensioned so that the connecting sleeve 22 projects in some regions into the connection chamber 19 in the inserted position, wherein it still has some distance to the base of the connection chamber 19 with its inner end, as can be seen well in FIG. 6. In this inserted position, the connecting sleeve 22 of the bleeding and filling tool 23 are held securely in the cover 17, so that the tool is reliably prevented from unintentionally slipping out even during handling during a bleeding or filling process.

The connection chamber 19 has open dimensions, which are greater than that of the projecting part of the connecting sleeve 22, so that there is still space for an overflow of hydraulic fluid through the overflow openings 21.

In the embodiment, the filling and bleeding opening 15 is arranged at the side next to the equalizing reservoir 14 and located on the highest side next to the equalizing reservoir 14 in the filling and bleeding position from FIG. 6. The cover 17 is here constructed so that it also overlaps this area of the dispenser housing 20 located at the side next to the equalizing reservoir 14.

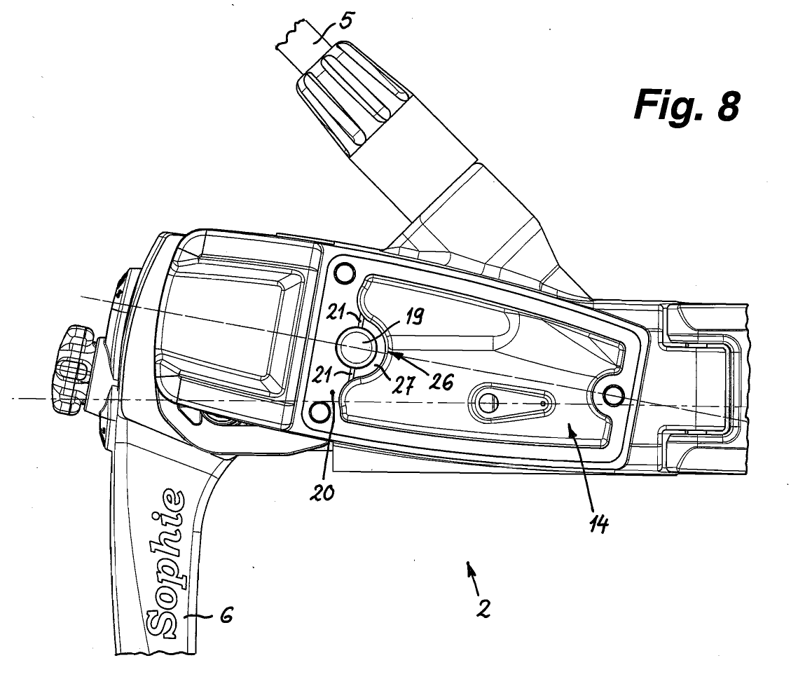

In FIG. 8, for an equalizing reservoir 14 that is open at the top, that is, without the cover 17 and removed bellows 30 (FIG. 13), it is easy to see that the connection chamber 19 of the filling and bleeding opening 15 is arranged in a bulge 26 of the dispenser housing 20 projecting laterally into the equalizing reservoir 14. The connection chamber 19 is here surrounded by a boundary wall 27, in which are located two slot-shaped overflow openings 21 that are open upwards at the edge. The two overflow openings 21 are here offset laterally to the front-most region of the bulge 26 facing the equalizing reservoir 14. In this way it is achieved that air bubbles possibly still located in the connection chamber 19 after a filling and bleeding process cannot be led into the equalizing reservoir 14 via the overflow openings 21 in the diagonal operating position of the dispensing system 2 shown in FIG. 7, but instead remain trapped in the somewhat higher lying part of the connection chamber 19. The fact that the overflow openings 21 are constructed as narrow edge slots also contributes to this, wherein the slot width is dimensioned for holding back air bubbles contained in the hydraulic fluid.

An elastic bellows 30, which, as can be seen in FIG. 13, has a trough shape and a surrounding seal 31 formed as a flange, is inserted into the equalizing reservoir 14. This bellows 31 is inserted into the equalizing reservoir 14 and fills up the reservoir in some sections. The seal 31 contacts the edge region of the equalizing reservoir and thus the dispenser housing 20. Through the attached cover 17, the bellows 30 and also the equalizing reservoir 14 are then closed and sealed from the outside. The hollow space of the bellows 30 is connected to the outer atmosphere via a bellows ventilation opening 32 (FIGS. 1 and 10) through the cover 17.

The surrounding seal 31, which is arranged between the equalizing reservoir 14 and the cover 17 sealing it at the top side and which is formed by the side flange of the bellows 30, also extends into the side region next to the equalizing reservoir 14 and here between the insertion section 18 and the connection chamber 19 of the filling and bleeding opening 15.

In this region, the seal 31 is provided with an annular bead 33, as can be easily seen in FIGS. 6 and 13.

In an approximately complementary way to this annular bead 33, the cover region surrounding the insertion section 18 has an annular groove 34 to receive this annular bead 33 in a sealing way (FIG. 12). The annular bead 33 contacts with its bottom side the top edge of the connection chamber 19 or its boundary wall 27 (FIG. 6). The overflow openings 21 located in the boundary wall 27 and open at the edge are bridged by the annular bead 33, wherein the increased inherent stability of the annular bead 33 in comparison with the flat construction of the seal in the adjacent region provides for a good seal also in the bridging region.

When the bleeding and filling tool 23 are removed, the filling and bleeding opening 15 can be closed with an elastic sealing plug 35 preferably provided with a cone (FIG. 5).

The filling and bleeding opening 15 preferably has an insertion section 18 with a holding cone 25, in which the sealing plug 35 provided with a matching external cone can be inserted. The sealing is realized here by the conical connection.

The sealing plug 35 can have an insertion hole that is accessible from the outside as a tool contact point for a turning tool. This contact point is preferably constructed as a hexagon socket for a hex wrench as a turning tool.

Therefore, after inserting the turning tool, the sealing plug 35 can be turned, for example, with this tool and in this way removed, supported by the conical connection. Through the internal tool contact point, the inserted sealing plug can lie flush with or even somewhat deeper than the outside of the cover or the opening of the insertion section 18 in the cover 17, so that unintentional loosening or removal of the sealing plug is practically ruled out.

The sealing plug can be made from a hard plastic material, for example, from the same material as the cover 17. Other materials can also be used, wherein all that must be reliably ensured is that the moment for turning the sealing plug 35 can be transferred from the turning tool.

It should be mentioned that instead of a sealing plug 35, a sealing screw can also be provided, which can be screwed into a threaded bore hole of the filling and bleeding opening 15, wherein the seal is reached through the end face.

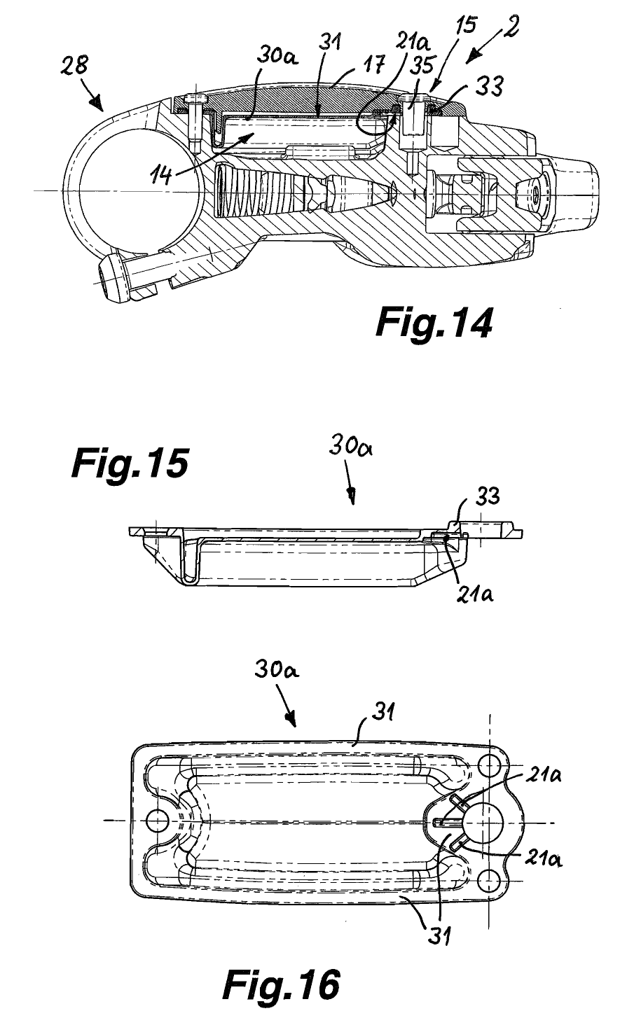

In the dispensing system 2 shown in section in FIG. 14, overflow openings 21a from the connection chamber to the equalizing reservoir are arranged, instead of in the boundary wall 27 of the connection chamber 19, as described above, in a counterpart, which contacts the boundary wall and which, in the embodiment, is the seal 31 between the cover and the equalizing reservoir as part of the bellows 30a. The seal 31 is here formed by the surrounding side flange of the elastic bellows 30a (FIGS. 15 and 16).

This seal or side flange extends past the region of the connection chamber 19 and its boundary wall 27, wherein, in the embodiment, the three, channel-shaped overflow openings 21a (FIG. 16) are arranged in the bellows side flange and thus the seal 31 and overlap the boundary wall 27, that is, project with their ends, on one side, into the equalizing reservoir 14 and, on the other side, into the connection chamber 19. Through these overflow openings or overflow channels, a flow connection is provided between the connection chamber 19 and the equalizing reservoir 14. The overflow openings 21a are constructed as grooves, which are open at the edge and which face the boundary wall 27 with their openings.

The seal 31 is thicker in the contact region with the boundary wall 27 of the connection chamber 19 (FIG. 15), so that, on one hand, an increased inherent stability is present in this region and, on the other hand, spatial relationships are provided for overflow openings 21a that are sufficiently dimensioned in cross section.

It should be mentioned that the one or more overflow openings 21 from the connection chamber 19 to the equalizing reservoir 14 can also be provided directly in the cover 17, if this cover is made from a suitable material for realizing a seal for the connection chamber 19. Here, the overflow openings are also arranged at the corresponding position like for the seal 31. Furthermore, the one or more overflow openings could also be constructed as a borehole in the side wall of the connection chamber 19. For shaping processes, like, for example, injection molding, however, overflow openings that are open at the edge can be realized easily.

The dispensing system 2 can be connected to the handlebars of a two-wheel vehicle by means of a holder 28. The holder 28 is constructed like a clamp and can be tightened or loosened with the help of a clamping screw 29. In this way, the dispensing system can be easily set into the matching position, on one hand, for the operation (FIGS. 5 and 7) and accordingly for good operability and, on the other hand, for the filling and bleeding process (FIGS. 4 and 6) accordingly.

It should be mentioned that the dispensing system 2 can be easily moved from a position with a nearly vertical bleeding and filling tool 23 as shown in FIGS. 4 and 6 to an approximately horizontal position of the bleeding and filling tool 23 for the filling and especially the bleeding process.

For filling the hydraulic system, the syringe forming the bleeding and filling tool 23 can be placed on the top side of the dispensing system 2 according to FIGS. 4, 6, and 9 and in this way inserted tightly into the holding cone 25 of the filling and bleeding opening 15 with its connecting sleeve 22. The provided conical connection produces a secure and tight connection with just slight pressure. For the brake mechanism 4, a container with hydraulic fluid can be connected to the filling and bleeding opening 16, wherein this container can also be a syringe filled with hydraulic fluid.

Preferably, the filling and bleeding opening 16 of the brake mechanism 4 is also provided with a Luer holding cone, so that here standard syringes can also be used as the bleeding and filling tool 23. With the syringe attached at the top in the dispensing system 2, the hydraulic fluid is suctioned and then flows from below into the hydraulic system. The lower syringe filled with hydraulic fluid can act in a supporting way, so that the filling process can be completed quickly.

What is claimed is:

1. Brake system with hydraulic brake equipment for two-wheel vehicles, the brake equipment comprising a dispensing system filled with hydraulic fluid and a brake mechanism hydraulically connected to the dispensing system, the dispensing system has an equalizing reservoir and a filling and bleeding opening, the filling and bleeding opening has an insertion section arranged in a cover of the equalizing reservoir for tightly holding a bleeding and filling tool connected in an insertion direction to a connection chamber in a dispenser housing, which has a side boundary wall to the equalizing reservoir, and at least one overflow opening to the equalizing reservoir that is open at an edge provided in the boundary wall.

2. The brake system according to claim 1, wherein the insertion section of the filling and bleeding opening is arranged for tightly holding a connecting sleeve of the bleeding and filling tool, the connecting sleeve projects in the connected position into a cup-shaped connection chamber, and the connection chamber has open inner dimensions, which are greater than a projecting part of the connecting sleeve.

3. The brake system according to claim 1, wherein the at least one overflow opening that is open at the edge in the boundary wall of the connection chamber is arranged in a region at a distance from a highest position of the side boundary wall in an operating position of the dispensing system.

4. The brake system according to claim 1, wherein the at least one overflow opening comprises two overflow openings provided in the boundary wall, which are arranged approximately opposite each other and which are open at the edge.

5. The brake system according to claim 4, wherein the overflow openings arranged in the boundary wall of the connection chamber are constructed as narrow edge slots and the slot width is dimensioned for holding back air bubbles contained in the hydraulic fluid.

6. The brake system according to claim 2, wherein the cover overlapping the equalizing reservoir and forming a sealed contact on the housing at the edge has the insertion section for the bleeding and filling tool at a side next to the equalizing reservoir, and the cup-shaped connection chamber connected in the insertion direction is located in the dispenser housing.

7. The brake system according to claim 1, wherein the connection chamber of the filling and bleeding opening is arranged in a bulge of the dispenser housing projecting into the equalizing reservoir.

8. The brake system according to claim 1, wherein the filling and bleeding opening is arranged at a highest side next to the equalizing reservoir in the filling and bleeding position of the dispensing system.

9. The brake system according to claim 1, wherein the filling and bleeding opening is arranged in a region of the cover overlapping the equalizing reservoir, the insertion section passes through the cover, and the connection chamber connected tightly in the insertion direction is located in the dispenser housing in a housing projection located within the equalizing reservoir.

10. The brake system according to claim 1, wherein a seal, which extends into a region between the insertion section and the adjacent connection chamber of the filling and bleeding opening, is provided between the equalizing reservoir and the cover sealing it on a top side thereof.

11. The brake system according to claim 10, wherein the seal is thicker at least in a contact region on the boundary wall of the connection chamber and the cover region facing it and surrounding the insertion section has an annular groove for sealed holding of the seal or the thicker seal region.

12. The brake system according to claims 1, wherein an elastic bellows is inserted into the equalizing reservoir, the elastic bellows is formed by a rubber-elastic molded body and which has at least one surrounding side flange as a seal between the equalizing reservoir and cover.

13. The brake system according to claim 12, wherein the elastic bellows has a hollow, trough-shaped, construction with a surrounding seal at an opening edge and a bellows bleeding opening is provided, which passes through the equalizing reservoir cover.

14. The brake system according to claim 12, wherein a bottom side of the bellows forms a diagonal guiding surface to a bleeding position in the filling and bleeding opening at least in the filling and bleeding position of the dispensing system.

15. The brake system according to claim 14, wherein an elastic sealing plug is provided, with a cone or a sealing screw for closing the filling and bleeding opening.

16. The brake system according to claim 1, wherein the bleeding and filling tool has a connecting sleeve or a similar connection element for sealed insertion into the filling and bleeding opening.

17. The brake system according to claim 16, wherein the connecting sleeve of the bleeding and filling tool has a Luer cone or a Luer lock and the filling and bleeding opening or an insertion section thereof arranged to fit the connecting sleeve.

18. The brake system according to claim 16, wherein the bleeding and filling tool has a piston/cylinder arrangement.

19. The brake system according to claim 16, wherein the bleeding and filling tool is a standard syringe.

20. The brake system according to claim 16, wherein the bleeding and filling tool is integrated into the dispensing system (2).

21. The brake system according to claim 1, wherein the brake mechanism has a filling and bleeding opening, which is arranged for detachable connection of the bleeding and filling tool.

22. The brake system according to claim 15, wherein the filling and bleeding opening has an insertion section with a holding cone and the sealing plug has a matching outer cone and also an insertion hollow accessible from outside as a tool contact point for a turning tool.

23. The brake system according to claim 22, wherein the insertion hollow of the sealing plug is a hexagon socket for a hex wrench as the turning tool.

24. The brake system according to claim 22, wherein the sealing plug inserted into the filling and bleeding opening forms an approximately flush seal with the opening of the insertion section or the cover.

25. The brake system according to claim 22, wherein the sealing plug is made from hard plastic material.

26. The brake system according to claim 22, wherein the outer cone of the sealing plug corresponds to a Luer cone.

27. The brake system according to claim 1, wherein the dispensing system is connected by a holder to a part of the two-wheel vehicle, which is arranged for setting the dispensing system at least into a filling and bleeding position (15) and an operating position.

28. The brake system according to claim 1, wherein the filling and bleeding opening has an insertion section arranged in a cover of the equalizing reservoir for tight holding of the bleeding and filling tool, which connects in the insertion direction to a connection chamber in the dispenser housing, which has a side boundary wall to the equalizing reservoir, and at least one overflow opening to the equalizing reservoir is provided in the boundary wall or in a counterpart contacting the boundary wall.

29. The brake system according to claim 28, wherein the at least one overflow opening from the connection chamber to the equalizing reservoir is provided in the cover.

30. The brake system according to claim 28, wherein the at least one overflow opening from the connection chamber to the equalizing reservoir is provided in a seal between the cover and the equalizing reservoir.

31. The brake system according to claim 30, wherein the at least one overflow opening provided in the seal is constructed as at least one groove, which is open at an edge in a region overlapping the boundary wall and which faces the boundary wall with an opening thereof.

32. The brake system according to claim 30, wherein the seal is thicker at least in the contact region on the boundary wall of the connection chamber and there has at least one, groove-shaped overflow opening that is open at the edge.

33. The brake system according to claim 30, wherein the seal with the one or more overflow openings is a surrounding side flange of an elastic bellows.
